(19) United States
(12) Patent Application Publication
(10) Pub. No.: US 2009/0235252 A1
(43) Pub. Date: Sep. 17, 2009

(54) EXECUTION-LEVEL PROCESS MODELING

(75) Inventors: Ingo Weber, Mannheim (DE); Norman May, Karlsruhe (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/049,755

(22) Filed: Mar. 17, 2008

(51) Int. Cl. G06F 9/46

(52) U.S. Cl. 718/100

(57) ABSTRACT

A system includes a semantic process validator that includes a state construction component that is configured to collect state information for an instance of a process model, a parallelity checker that is configured to determine a set of one or more process tasks within the instance of the process model that may be executed in parallel to a selected task, and a validation coordinator that is configured to coordinate requests to the state construction component and to the parallelity checker. The system includes a process modeling tool that includes a goal creator that is configured to construct a constraint set for the selected task using the set of process tasks, where the selected task has a goal. The system includes a task composer that is configured to find one or more services to fulfill the goal for the selected task using the constraint set.

### TECHNICAL FIELD

This description relates to execution-level process modeling.

### BACKGROUND

With the growth of information technology (IT) industries, companies have increasing needs to manage processes such as their business processes as easily as possible based on covering activities in company processes by software. For example, a company may investigate business process models for tasks that may be replaced or emulated by computer programs. Such business process models may include scalable software fragments that may be reusable and easy to access. For example, Web services may be used to cover as many parts of a process model as possible. For example, software developers may investigate models generated by business experts using a Service Oriented Design principle.

By using loosely coupled web services, such as supported by Service Oriented Architecture (SOA) designs, developers may design software which is flexible and reusable, and which may be easily adapted to varying user needs within short time frames and without great effort in term of costs and manpower.

Many users such as businesses and companies use business process models to represent behavior that is used to solve specific problems that may occur repeatedly or on regular basis. Thus, a problem may be decomposed into smaller sub-problems or atoms, each fulfilling a task that may help to achieve an overall goal. An example business process model may include modeled activities that may be located relative to each other in the model via directed edges. This technique may be combined with a Service Oriented Architecture design by using web services to fulfill the specific tasks of a process model that may provide the desired outcome of a process, for example, via an executable process model. Changes in process models or requirement changes may then be realized by adding new processes, or extending functionality of existing processes.

Software developers currently may be asked to transform business process models into executable programs, wherein composed web services may replace a stationary approach, in which a program may have previously been developed to run on only one server, not reusing or enacting networked services. However, the software developer may experience some difficulties in correctly transforming a model designed by a business expert into an executable business process. For example, a software developer may have a completely different view of the approach, lacking background knowledge that may be helpful to perform a desired task, whereas a business process model designer may not model a formally correct process model, wherein all activities may be reached and wherein executions of the process model may not reach unintended halts. Generally, a software developer may lack business knowledge and a business expert may lack a proper IT background, which may lead to process models that may be inefficient in execution, and which may lead to semantically or formally erroneous process model execution approaches. Thus, it may be desirable to automatically transform a business process model generated by a business expert into an executable model, accounting for all information given by the modeler.

### SUMMARY

In one general aspect, a system includes a semantic process validator that is arranged and configured to include a state construction component that is arranged and configured to collect state information for an instance of a process model, a parallelity checker that is arranged and configured to determine a set of one or more process tasks within the instance of the process model that may be executed in parallel to a selected task, and a validation coordinator that is arranged and configured to coordinate requests to the state construction component and to the parallelity checker. The system also includes a process modeling tool that is arranged and configured to include a goal creator that is arranged and configured to construct a constraint set for the selected task using the set of process tasks determined by the parallelity checker, where the selected task has a goal. The system also includes a task composer that is arranged and configured to find one or more services to fulfill the goal for the selected task using the constraint set constructed by the goal creator.

Implementations may include one or more of the following features. For example, the goal creator may be arranged and configured to construct the constraint set for the selected task prior to the task composer finding the one or more services to fulfill the goal for the selected task. The goal creator may be further arranged and configured to compute expanded preconditions for the selected task using the state information for the instance of the process model collected by the state construction component and the task composer may be further arranged and configured to find the one or more services to fulfill the goal for the selected task using the constraint set constructed by the goal creator and the expanded preconditions computed by the goal creator. The goal creator may be arranged and configured to compute the expanded preconditions for the selected task prior to the task composer finding the one or more services to fulfill the goal for the selected task.

The validation coordinator may be further arranged and configured to coordinate execution of the parallelity checker prior to execution of the state construction component.

The process modeling tool may further includes a user interface that is arranged and configured to interact with a user and to enable the user to control the process modeling tool. The process modeling tool may further include a user interface that is arranged and configured to interact with a user and to enable the user to configure the task composer.

In one exemplary implementation, the goal creator may be further arranged and configured to compute expanded preconditions for the selected task using the state information for the instance of the process model collected by the state construction component and the process modeling tool may further include a user interface that is arranged and configured to interact with a user and to enable the user to control the process modeling tool including controlling the task composer by configuring the task controller to remove the constraint set from consideration by the task composer when finding the one or more services to fulfill the goal for the selected task. The task composer may be further arranged and configured to find the one or more services to fulfill the goal for the selected task using only the expanded preconditions computed by the goal creator.

In another general aspect, a computer program product for performing task composition may be tangibly embodied on a computer-readable medium and include executable code that, when executed, is configured to cause at least one data processing apparatus to execute a semantic process validator, a process modeling tool and a task composer. The semantic process validator may be arranged and configured to include a state construction component that is arranged and configured to collect state information for an instance of a process model, a parallelity checker that is arranged and configured to determine a set of one or more process tasks within the instance of the process model that may be executed in parallel to a selected task, and a validation coordinator that is arranged and configured to coordinate requests to the state construction component and to the parallelity checker. The process modeling tool may be arranged and configured to include a goal creator that is arranged and configured to compute expanded preconditions for the selected task using the state information for the instance of the process model collected by the state construction component, the selected task having a goal. The task composer may be arranged and configured to find one or more services to fulfill the goal for the selected task using the expanded preconditions computed by the goal creator.

Implementations may include one or more of the following features. For example, the goal creator may be arranged and configured to compute the expanded preconditions for the selected task prior to the task composer finding the one or more services to fulfill the goal for the selected task. The goal creator may be further arranged and configured to construct a constraint set for the selected task using the set of process tasks determined by the parallelity checker and the task composer may be further arranged and configured to find the one or more services to fulfill the goal for the selected task using the constraint set constructed by the goal creator and the expanded preconditions computed by the goal creator. The goal creator may be arranged and configured to construct the constraint set for the selected task prior to the task composer finding the one or more services to fulfill the goal for the selected task.

The validation coordinator may be further arranged and configured to coordinate execution of the parallelity checker prior to execution of the state construction component.

The process modeling tool may further include a user interface that is arranged and configured to interact with a user and to enable the user to control the process modeling tool. The process modeling tool may further include a user interface that is arranged and configured to interact with a user and to enable the user to configure the task composer.

In one exemplary implementation, the goal creator may be further arranged and configured to construct a constraint set for the selected task using the set of process tasks determined by the parallelity checker, the process modeling tool may further include a user interface that is arranged and configured to interact with a user and to enable the user to control the process modeling tool including controlling the task composer by configuring the task controller to remove the expanded preconditions from consideration by the task composer when finding the one or more services to fulfill the goal for the selected task, and the task composer may be further arranged and configured to find the one or more services to fulfill the goal for the selected task using only the constraint set constructed by the goal creator.

In another general aspect, a method may include collecting state information for an instance of a process model, determining a set of one or more process tasks within the instance of the process model that may be executed in parallel to a selected task with the selected task having a goal, coordinating requests for collecting the state information and for determining the set of the one or more process tasks, constructing a constraint set for the selected task using the set of the one or more process tasks within the instance of the process model that may be executed in parallel to the selected task, and finding one or more services to fulfill the goal for the selected task using the constraint set.

Implementations may include one or more of the following features. For example, the method may further include computing expanded preconditions for the selected task using the state information for the instance of the process model, where finding the one or more services may include finding the one or more services to fulfill the goal for the selected task using the constraint set and the expanded preconditions.

In one exemplary implementation, the method may further include computing expanded preconditions for the selected task using the state information for the instance of the process model and removing the constraint set from consideration when finding the one or more services to fulfill the goal for the selected task, where finding the one or more services includes finding the one or more services to fulfill the goal for the selected task using only the expanded preconditions. The method also may include enabling a user to remove the constraint set from consideration when finding the one or more services to fulfill the goal for the selected task.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system of execution-level process modeling.

FIG. 2 is a flowchart illustrating an operation of the example system of FIG. 1.

FIG. 3 is a block diagram of an example process modeled in Business Process Modeling Notation (BPMN) notation.

FIG. 4 is a diagram of an example search space.

FIG. 5 is a diagram of an example search space having expanded preconditions.

FIG. 6 is a diagram of an example search space having a constraint set.

FIG. 7 is a diagram of an example search space having expanded preconditions and a constraint set.

FIG. 8 is a diagram of an example search space having a constraint set.

FIG. 9 is a diagram of an example search space having expanded preconditions and a constraint set.

FIG. 10 is a block diagram of an example system for validating process semantic models.

FIG. 11 is a block diagram of an example system for validating process state models.

### DETAILED DESCRIPTION

In one exemplary implementation, executable process models may be derived from semantically annotated graphical business process models in an automated manner. Systems and methods from semantic business process validation may be applied to task composition and/or task discovery while modeling a business process. More specifically, systems and methods related to I-propagation for the generation of logical states at given points in a process model and systems and methods related to a parallelity check may be applied to task composition and/or task discovery while modeling a business process. Applying these systems and methods to task composition and/or task discovery may lead to early conflict detection and/or avoidance and may lead to a higher probability of finding a potentially better solution due to the generation of expanded preconditions for task composition and/or task discovery.

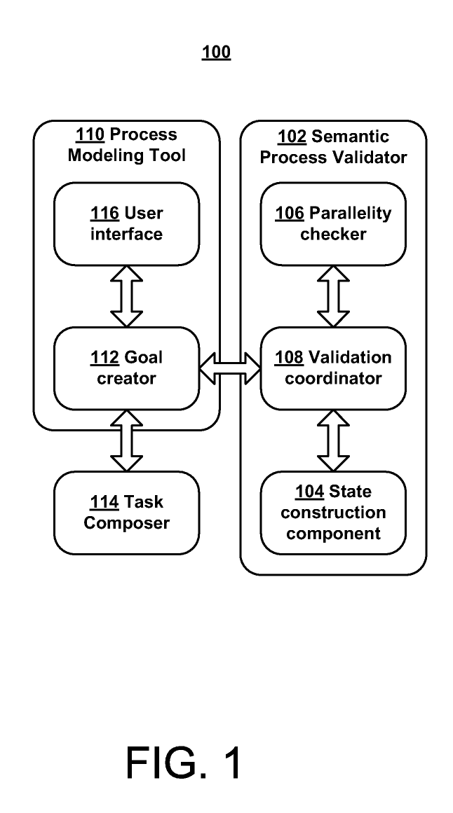

Referring to FIG. 1, a system 100 for execution-level process modeling is illustrated. The system 100 may include a semantic process validator 102, which may include a state construction component 104, a parallelity checker 106, and a validation coordinator 108. The system 100 also may include a process modeling tool 110 which may include a goal creator 112. The system 100 also may include a task composer 114. In one exemplary implementation, the process modeling tool 110 also may include a user interface 116.

Given an orchestration of semantically annotated services (e.g., web services) embedded into an executable process, the semantic process validator 102 may be arranged and configured to check whether or not the preconditions of processes that can be evaluated in parallel can establish execution states that may be in conflict with a services precondition. The semantic process validator 102 may use one or more of its subcomponents to perform one or more of these functions.

The semantic process validator 102 may include the state construction component 104. The state construction component 104 may be arranged and configured to collect state information for an instance of a process model. The state construction component 104 may assess the states through which the instance of the process model may go through during execution. The state construction component 104 may collect information about a state, which may be known to hold for any possible execution of the process before or after execution of a task in this process. In this manner, the state construction component 104 may collect and contain the logical statements which may hold true for any execution of the process model.

In one exemplary implementation, the state construction component 104 may collect more or different information. For example, the state construction component 104 may collect state information for an instance for a process model, where the state information may only hold true for a subset of the execution instances of the process model. Thus, the state information collected may not hold true for every execution of the process model.

The semantic process validator 102 may include the parallelity checker 106. The parallelity checker 106 may be arranged and configured to determine a set of one or more process tasks within the instance of the process model that may be executed in parallel to a selected task. For example, for each task in a process model, the parallelity checker 106 may determine whether or not there are one or more other process tasks that may be executed in parallel to the selected task.

A task or activity may be annotated with a common ontology. For example, a modeler of a business process may use an ontology to annotate the tasks with their effect, also known as postconditions. The modeler also may optionally annotate the tasks with preconditions. The combination of preconditions and postconditions for a task may be referred to as a goal.

The semantic process validator 102 may include the validation coordinator 108. The validation coordinator 108 may be arranged and configured to coordinate requests to the state construction component 104 and to the parallelity checker 106. In one exemplary implementation, the validation coordinator 102 may communicate with the goal creator 112 in the process modeling tool 110. The validation coordinator 108 may coordinate requests to the state construction component 104 and the to the parallelity checker 106, where the requests may originate from the goal creator 112 in the process modeling tool 110.

In one exemplary implementation, the validation coordinator 108 may be arranged and configured to coordinate execution of the parallelity checker 106 prior to execution of the state construction component 104.

The process modeling tool 110 may be arranged and configured to perform as a tool to model and implement business processes that may be executed by a process execution engine. The process modeling tool 110 may use a graphic modeling notation such as, for example, Business Process Modeling Notation (BPMN) or Unified Modeling Language (UML) activity diagrams.

The process modeling tool 110 may include the goal creator 112. The goal creator 112 may be arranged and configured to construct a constraint set for a selected task using the set of process tasks determined by the parallelity checker 106. The goal creator 112 also may be arranged and configured to compute expanded preconditions for the selected task using the state information for the instance of the process model collected by the state construction component 104. Using the constraint set and/or the expanded preconditions, the goal creator 112 may create a goal for the selected task.

The goal creator 112 may communicate with the validation coordinator 108 to request the desired information from the parallelity checker 106 and the state construction component 104. As discussed above, the validation coordinator 108 may coordinate the request to retrieve the information in an appropriate order and manner from the parallelity checker 106 and the state construction component 104.

The constraint set information constructed by the goal creator 112 may be derived from the information gathered by the parallelity checker 106. The constraint set may include a union of preconditions and postconditions for the one or more tasks that may be executed in parallel to the selected task. Thus, the constraint set may be useful during task composition to find a valid service that does not violate any of the preconditions and/or postconditions of the parallel tasks.

The expanded preconditions computed by the goal creator 112 may be derived from the information gathered by the state construction component 104. The expanded preconditions may include the preconditions for each task and the state of each path for a task (e.g., the state of the world entering a task).

The task composer 114 may be arranged and configured to find one or more services (e.g., web services) to fulfill the goal for the selected task using the constraint set constructed by the goal creator 112 and/or the expanded preconditions computed by the goal creator 112. In this manner, all information that may be known and available about the process model is taken into account during task composition. The expanded preconditions may describe under which conditions a service is executable. In other words, if a given state satisfies the preconditions, the service can be executed. The use of the expanded preconditions, preconditions are automatically inferred because they are known to hold true for a particular task. By applying the postconditions, the state after the service execution can be determined. The constraint set may impose constraints on the states that may be produced as intermediate states in a service composition.

An available service (e.g., web service) may be annotated with its preconditions and its effect, i.e., the postcondition it establishes. The task composer 114 may be arranged and configured to perform task discovery and/or task composition. Task discovery may include a fuzzy search that may result in a direct match for a single service. Task composition may include a more exact search for a sequence of services.

Thus, multiple tasks and the information related to multiple tasks are taken into account during task composition for a selected task. Since more information is being taken into account during task composition and since task composition may be performed in isolation, meaning it is performed one task at a time, potential conflicts between multiple tasks may be avoided or at the least detected and identified earlier on during the modeling process.

In this manner, the system 100 may enable a reduced effort and increased efficiency in modeling business processes. As part of the modeling process, as opposed to the validation process, inconsistencies may be detected much earlier leading to a more efficient modeling and implementation cycle. By using available context information, including the expanded preconditions, a task composition may be computed to find a service or sequence of services, when previously this may not have been possible. The creation of an executable process model may be carried out faster because many inconsistencies are not even generated, and hence do not need to be detected during a validation process. The overall business process modeling effort may become more time and cost efficient because it can benefit from early detection of inconsistencies and better error diagnostics.

The process modeling tool 110 also may include the user interface 116. The user interface 116 may be arranged and configured to interact with a user and to enable the user to control the process modeling tool 110. In one exemplary implementation, the user interface 116 may be configured to enable the user to configure the goal creator 112 and/or the task composer 114. Feedback related to task composition and the finding of services is provided to the user through the user interface 116.

In one exemplary implementation, the user interface 116 may be used to trigger task composition for a selected task. This may done explicitly by a function invocation or it may be done implicitly, for example, after the user has finished defining the task. This may create a request to the goal creator 112, which may in turn request information from the state construction component 104 and the parallelity checker 106 through the validation coordinator 106. The goal creator 112 may use the information collected by the state construction component 104 and the parallelity checker 106 to construct the constraint set and/or compute the expanded preconditions prior to the task composer 114 finding the one or more services to fulfill the goal for the selected task.

In one exemplary implementation, the user may be able to configure the goal creator 112 and/or the task composer 114 to remove the expanded preconditions and/or the constraint set from consideration by the task composer 114 when finding the one or more services to fulfill the goal for the selected task. In this manner, the user may be provided with increased flexibility during the business modeling process.

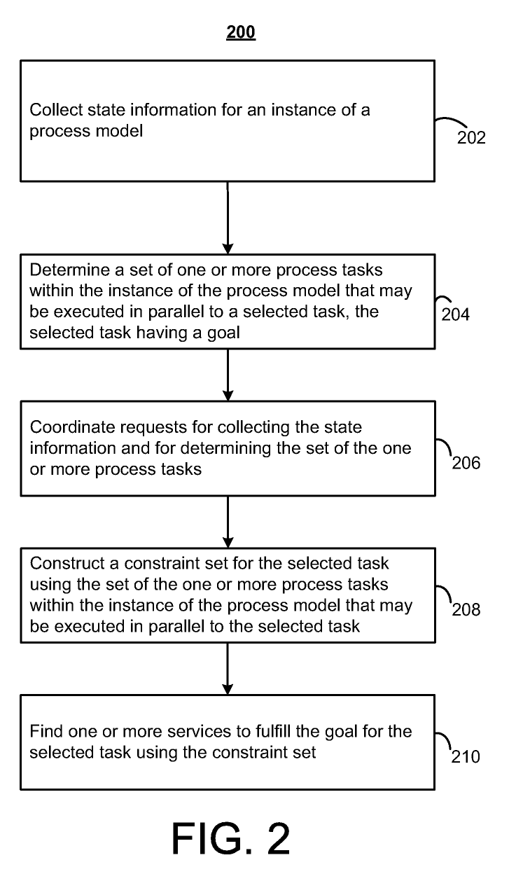

Referring to FIG. 2, a process 200 is illustrated to provide an example operation of system 100 of FIG. 1. Process 200 may include collecting state information for an instance of a process model (202), determining a set of one or more process tasks within the instance of the process model that may be executed in parallel to a selected task (204), coordinating requests for collecting the state information and for determining the set of the one or more process tasks (206), constructing a constraint set for the selected task using the set of the one or more process tasks within the instance of the process model that may be executed in parallel to the selected task (208) and finding one or more services (e.g., web services) to fulfill the goal for the selected task using the constraint set (210). It is to be understood that the operations of process 200 may not be required to be performed in a particular order. For example, coordinating requests for collecting the state information and for determining the set of the one or more process tasks (206) and constructing a constraint set for the selected task using the set of the one or more process tasks within the instance of the process model that may be executed in parallel to the selected task (208) may be performed in any order.

For example, the state construction component 104 may be arranged and configured to collect the state information for the instance of the process model (202). The parallelity checker 106 may be arranged and configured to determine the set of the one or more process tasks within the instance of the process model that may be executed in parallel to the selected task (204). The validation coordinator 108 may be arranged and configured to coordinate the requests for collecting the state information and for determining the set of the one or more process tasks (206).

The goal creator 112 may be arranged and configured to construct the constraint set for the selected task using the set of the one or more process tasks within the instance of the process model that may be executed in parallel with the selected task (208). Process 200 may further include computing expanded preconditions for the selected task using the state information for the instance of the process model. For example, the goal creator 112 may be arranged and configured to compute the expanded preconditions for the selected task using the state information for the instance of the process model.

The task composer 114 may be arranged and configured to find one or more services to fulfill the goal for the selected task using the constraint set (210). Process 200 may further include finding the one or more services to fulfill the goal for the selected task using the constraint set and the expanded preconditions. For example, the task composer 114 may be arranged and configured to find the one or more services to fulfill the goal for the selected task using the constraint set and the expanded preconditions.

In another exemplary implementation, process 200 may include computing the expanded preconditions for the selected task using the state information for the instance of the process model, removing the constraint set from consideration when finding the one or more services to fulfill the goal for the selected task. Finding the one or more services (210) may include finding the one or more services to fulfill the goal for the selected task using only the expanded preconditions. In another exemplary implementation, process 200 may include enabling a user to remove the constraint set from consideration when finding the one or more services to fulfill the goal for the selected task.

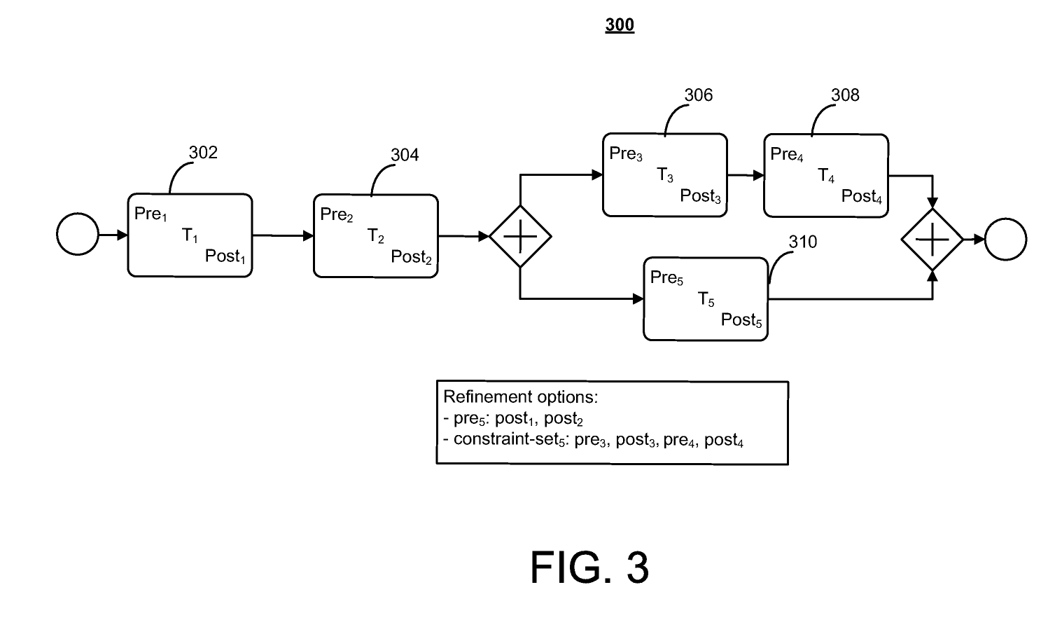

FIG. 3 illustrates a block diagram of an example process modeled using BPMN notation 300. Sequence structure 300 includes tasks T₁ 302, T₂ 304, T₃ 306, T₄ 308 and T₅ 310. In one exemplary implementation, the parallelity checker 106 derives that T₅ 310 is executed in parallel with T₃ 306 and T₄ 308. Thus, these two tasks may potentially be in conflict with T₅ 310. The state construction component 104 may yield pre₅¹ =pre₅ ∪ post₁ ∪ post₂−( [symbol] post₃ ∪ [symbol] post₄) assuming that post₁ ∩ post₂=0, i.e. post₂ only adds new conditions to the overall state of the process but does not destroy any state established bypost₁. Pre₅′ may not conflict with the effects of tasks that are executed in parallel. This is an additional constraint, which may improve the efficiency and precision of discovery. Since the postcondition of T₅ 310 must be consistent with all intermediate states that maybe required or created in/by tasks executed in parallel, the goal creator 112 may construct the constraint set to be constraint-set₅= [symbol] (pre₃ ∪ post₃) ∪ [symbol] (pre₄ ∪ post₄). Thus, in this example, the goal creator 112 may use the information gathered by the parallelity checker 106 to construct the constraint set for task T₅ 310. If the intersection of any state “S” during the execution of task T₅ with constraint-set 5 is non-empty, then a conflict may be detected.

For example, with respect to FIG. 3, assume that the ontology contains the literals “haveCar”, “poor”, “rich”, “paysBills”, “haveProgram”, and that the theory says that being rich and being poor are mutually exclusive as well as that if you are rich, you usually pay your bills. In this example, task T₂ 304 may be the task of selling your car and thus annotated with the precondition pre₂=[haveCar(me) ̂ê poor(me)] and the postcondition post₂=[ [symbol] haveCar(me)̂ rich(me)], where me is a process variable. The theory enables one to derive the following implicit effects: [symbol] poor(me)̂paysBills(me), and post₂=[ [symbol] haveCar(me)̂rich(me)̂ [symbol] poor(me)̂paysBills(me)].

Also, in this example, task T₅ 310 may be the task of implementing the “PayBill” action. Task T₅ 310 may be annotated with the precondition pre₅:=[paysBill(me)] and postcondition post₅:=[billPaid(me)̂poor(me)]. Furthermore, in this example, task T₃ may be annotated with pre₃:=[rich(me)̂ [symbol] haveProgram(me)] and post₃:=[haveProgram]. If looked at in isolation without taking any constraint set into account, then task composition for task T₃ may reveal two services available: buyComputer and writeProgram with pre_{buyComputer}:=[rich(x)], post_{buyComputer}:=[ [symbol] rich(x)̂haveComputer(x)], pre_{writeProgram}:=[haveComputer(x)], and post_{writeProgram}:=[haveProgram(x)]. In this example, the resulting composition of services contains the literal [symbol] rich(x) as part of its state. In fact, this is a non-obvious inconsistency that would not be detected until later during the process, for example, during process validation. When task composition is performed in isolation for every task without taking any constraint sets into account, inconsistencies like this one can be the result.

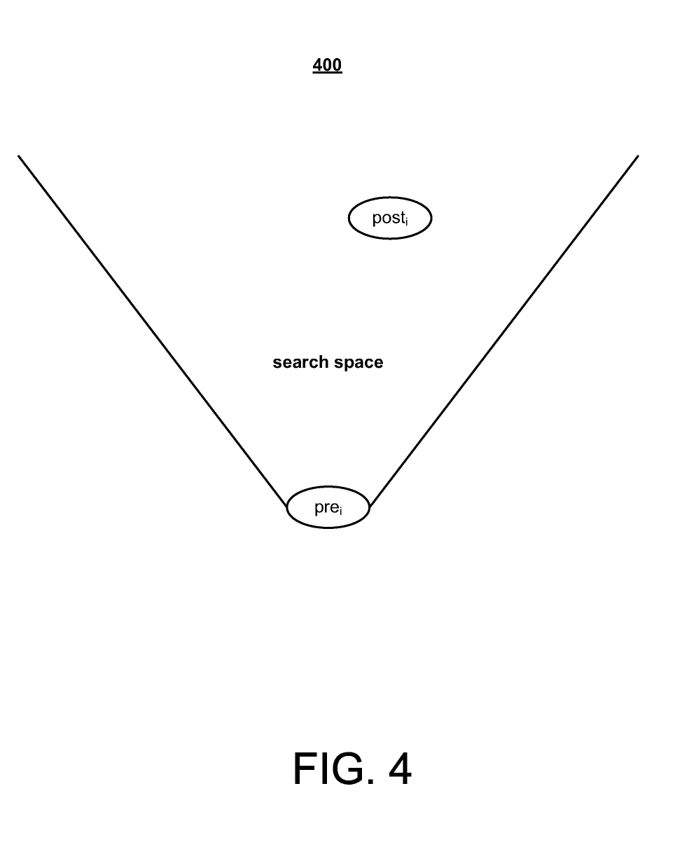

Referring to FIG. 4, an example search space 400 is illustrated. In this example, the search space is the area between the two lines and includes the available services that may be found during task composition to fulfill a goal for a selected task. The preconditions are the starting state for the task and the service(s) is what takes the task to the postcondition state. A solution path is valid if the entire solution path stays within the boundaries of the search space. In example search space 400, no expanded preconditions have been applied and no constraint sets have been applied.

Thus, example search space 400 is an exemplary, unchanged search space, where the search starts from preᵢ and tries to reach postᵢ. Possible solutions can be depicted as paths from preᵢ to postᵢ. For instance, with respect to the example of FIG. 3, solutions for services for tasks T₂ 304, T₃ 306 and T₅ may be determined in isolation without applying any expanded preconditions and/or constraint sets, such as illustrated in search space 400. One risk of determining a solution in isolation without applying any expanded preconditions and/or constraint set is that services may be composed for a task, but the service may be in conflict with another service composed for another task in isolation. In the example discussed above, the composition of services for task T₃ 306 may result in an inconsistency if the composition is performed in isolation in an unchanged search space such as search space 400.

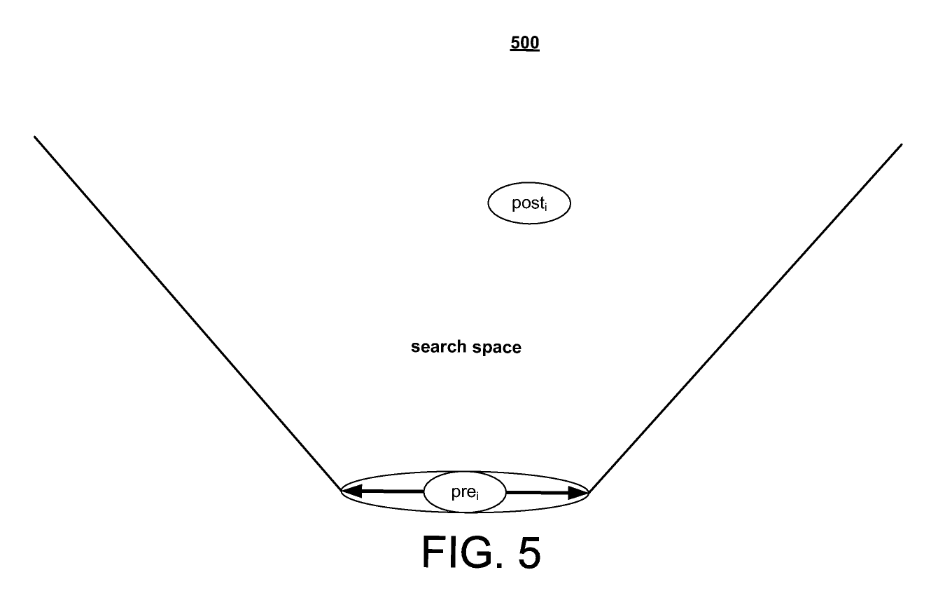

Referring to FIG. 5, an example search space 500 is illustrated. In this example search space 500, expanded preconditions have been applied such that during task composition more choices to orchestrate services are available. As can be seen when search space 500 is compared to search space 400 of FIG. 4, more relevant services may be discovered because the discovered services can rely on more preconditions. This increases the choices to orchestrate services, and thus it becomes more likely to find any valid orchestrations of services in search space 500 than in search space 400.

In general, the expanded preconditions allows discovery of additional applicable services, because the discovered services can rely on more known preconditions. Referring back to FIG. 4, imagine that the goal, i.e., the postcondition postᵢ, was not completely inside the search space 400, but that in search space 500 of FIG. 5 it was. This means that a previously unsatisfiable goal becomes satisfiable by using the expanded preconditions.

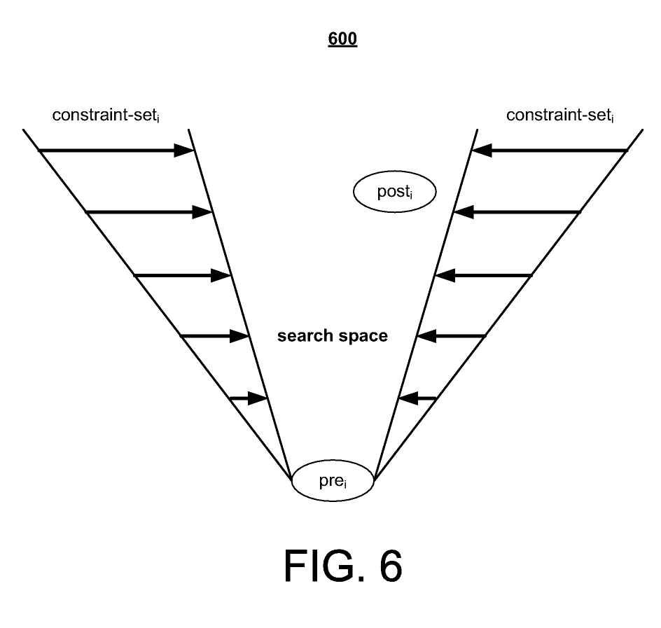

Referring to FIG. 6, an example search space 600 is illustrated. In this example search space 600, a constraint set has been applied. Unlike preconditions and postconditions, which are conjunctive formulae, a constraint set is a set of literals interpreted as a disjunctive formula, which expresses constraints on the states that may be reached during the execution of a task. If one of the literals from the constraint set appears, the constraint set is violated. The constraint set may be computed as the negated union of all preconditions and postconditions of the tasks that may be executed in parallel to the selected task. The constraint set constrains the search space considered during task composition. Although the constraint set may narrow the search space that is considered, a resulting solution can be assured of not violating any tasks that are in parallel to the selected task. The use of the constraint set during task composition may provide earlier conflict detection and avoidance. For instance, with respect to the above example for task T₃, the composition of services would not result in any inconsistencies because the application of the constraint set would eliminate conflicting services from consideration.

Referring back to the example of FIG. 3, suppose a solution for the task T₅ 310 would conflict with a solution for the task T₃ 306. By applying the constraint set prior to task composition, the conflicting solution would not be an option to begin with because the constraint set would preclude that solution from even being considered.

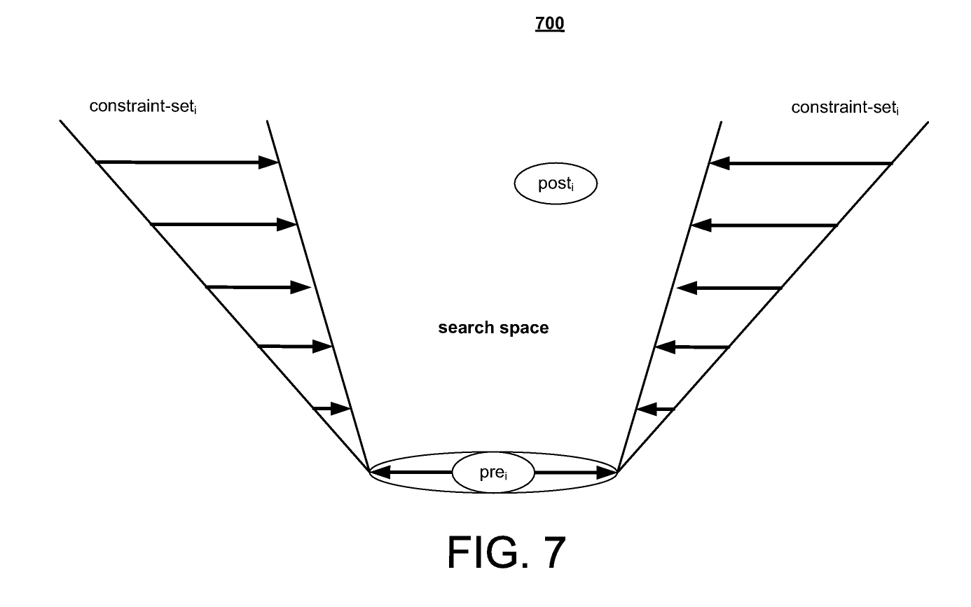

Referring to FIG. 7, an example search space 700 is illustrated. In this example search space 700, both expanded preconditions and a constraint set have been applied. With the expanded preconditions, further relevant services are included in the search space. With the constraint set, the search space is restricted to valid orchestrations of tasks.

Referring back to the example of FIG. 3, the expanded preconditions of search space 700 enable more relevant services to be discovered for the selected tasks. Specifically, the search space 700 may include those relevant services which may rely on postconditions established by predecessors of a task that cannot be derived from the preconditions of a task alone. Furthermore, the search space 700 does not even generate a solution in which the implementation of task T₃ may be in conflict with task T₅.

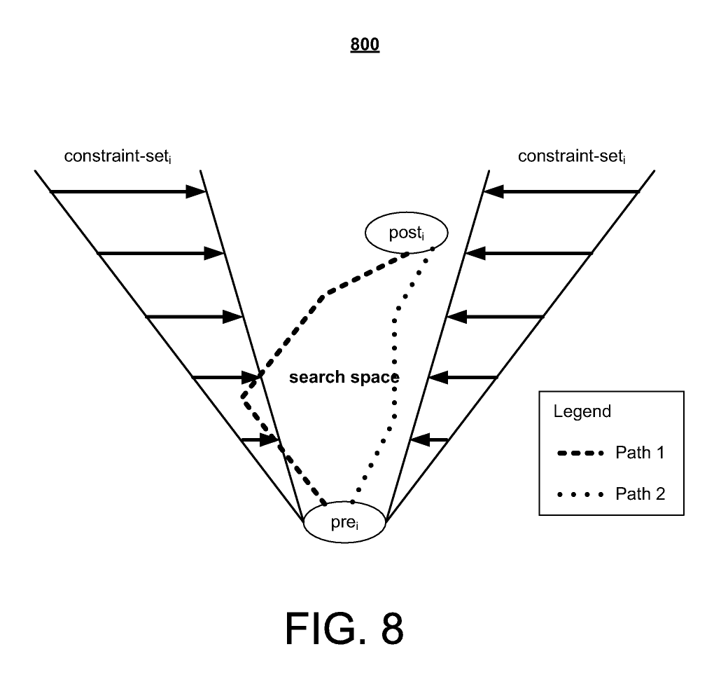

Referring to FIG. 8, an example search space 800 is illustrated. In this example search space 800, a constraint set has been applied. Solution Path 1 leads through a region which is out of the boundaries when the constraint set is taken into account. It is noted that Path 1 would appear to be valid had the constraint set not been taken into account. In this example, Path 2 is a valid solution path.

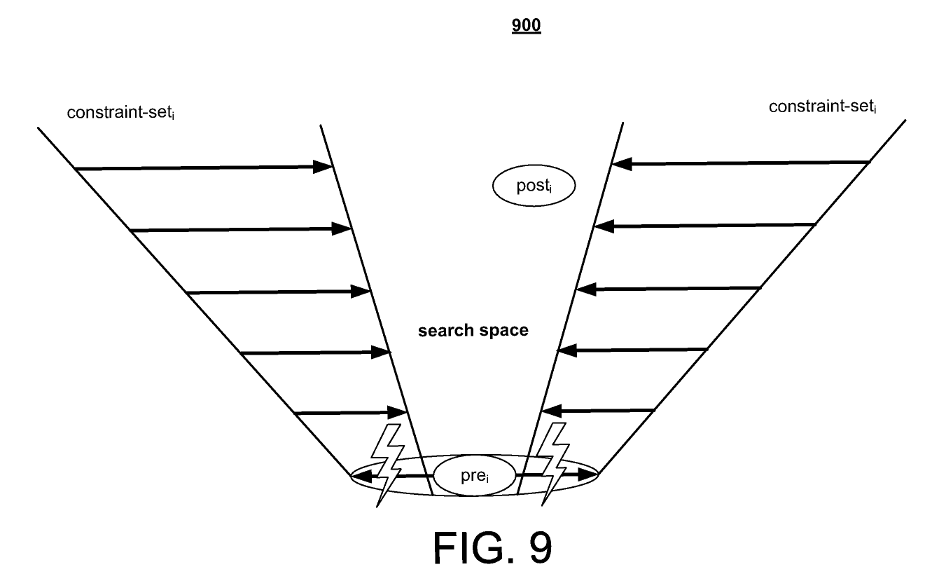

Referring to FIG. 9, an example search space 900 is illustrated. In this example, the expanded preconditions are in conflict with the constraint set. In this case, the respective goal for the selected task may not be satisfied and a user may not want to consider any solution for this situation. In this example, the conflict may be removed by removing the expanded preconditions from consideration.

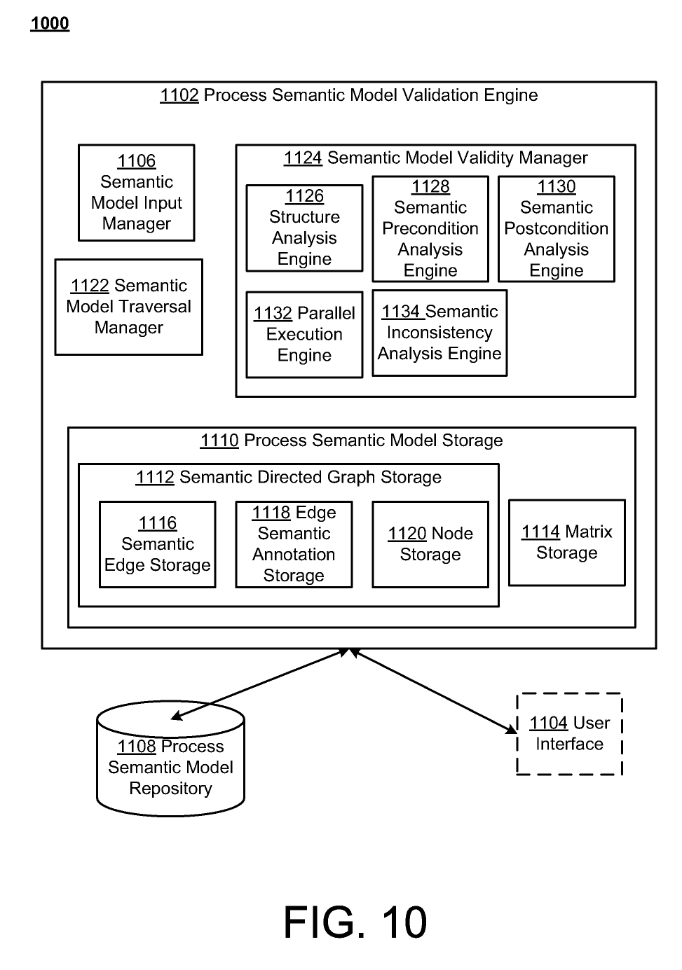

FIG. 10 is a block diagram of a system 1000 for validating process models, for example, business process models. In the example of FIG. 10, a process semantic model validation engine 1102 includes various processing engines that provide and process models that may be displayed, for example, for users via a user interface 1104. For example, the user may view via a graphical user interface process models to determine validity of execution of tasks represented by the process models.

The parallelity checker 106 of FIG. 1 also may be referred to a the process semantic model validation engine 1102 and may perform its functionality in a same or similar manner. The process semantic model validation engine 1102 may include a semantic model input manager 1106 configured to obtain a process semantic model including a semantic directed graph including nodes associated with tasks and edges associated with a direction of flow of execution of the tasks, wherein edges entering nodes include annotations including precondition semantic indicators associated with the edges entering the nodes and edges exiting nodes include annotations including postcondition semantic indicators associated with the edges exiting the nodes. For example, the semantic model input manager 11 06 may obtain the process semantic model from a process semantic model repository 1108 configured to store process semantic models such as business process models. According to an example implementation, the process semantic model may include a model associated with web services. According to an example implementation, the web services may include semantic web services.

According to an example implementation, the process semantic model validation engine 1102 may include a process semantic model storage area 1110 configured to store information associated with the process semantic model obtained by the process semantic model validation engine 1102. According to an example implementation, the process semantic model storage area 1110 may include a semantic directed graph storage area 1112 configured to store information associated with the semantic directed graph, and a matrix storage area 1114 configured to store information associated with a matrix associated with the semantic directed graph.

According to an example implementation, the semantic directed graph storage area 1112 may include a semantic edge storage area 1116 configured to store information associated with the edges, an edge semantic annotation storage area 1118 configured to store information associated with the edge annotations, and a node storage area 1120 configured to store information associated with the nodes.

According to an example implementation, the process semantic model validation engine 1102 may include a semantic model traversal manager 1122 configured to traverse the process semantic model to determine a flow of execution of activities associated with the tasks based on visiting the nodes based on a depth-first traversal.

According to an example implementation, workflow structures included in the semantic directed graph may include one or more of a parallel execution workflow structure, a sequential execution workflow structure, a split execution workflow structure, or a merge execution structure. One skilled in the art of data processing may appreciate that many other types of workflow structures may also be included. According to an example implementation, paths included in the semantic directed graph may include a logical sequence of a group of the activities and a list of indicators associated with preconditions and postconditions associated with the group of activities.

According to an example implementation, the process semantic model validation engine 1102 may include a semantic model validity manager 1124 configured to determine a validity of execution associated with a flow of execution of the activities associated with the tasks based on checking a validity of execution status based on a semantic processing of one or more semantic annotation indicators associated with the precondition semantic indicators and the postcondition semantic indicators.

According to an example implementation, the semantic model traversal manager 1122 may be further configured to determine a checking indicator indicating a checking relationship between each traversed path and previously traversed paths included in workflow structures included in the semantic directed graph, wherein each traversed path and each previously traversed path includes one or more nodes included in the semantic directed graph. For each traversed path, a list of semantic annotation indicators associated with the precondition semantic indicators and the postcondition indicators associated with the each traversed path may be generated. The checking indicator may be stored in a matrix that includes rows associated with the paths included in the workflow structures included in the semantic directed graph.

According to an example implementation, the semantic model validity manager 1124 may be further configured to determine the validity of execution based on determining the validity of execution associated with a flow of execution of the activities associated with the tasks based on checking a validity of execution status based on the checking indicators stored in the matrix and a semantic processing of the semantic annotation indicators included in one or more of the lists of semantic annotation indicators.

According to an example implementation, the semantic model validity manager 1124 may include a structure analysis engine 1126 configured to determine that a first and second one of the nodes are included in a parallel execution structure included in the workflow structures.

According to an example implementation, the semantic model validity manager 1124 may include a semantic precondition analysis engine 1128 configured to determine, for the first one of the nodes, whether first precondition semantic indicators associated with a first edge entering the first one indicate one or more positive values indicating a positive validity of execution of activities associated with the tasks associated with the first one.

According to an example implementation, the semantic precondition analysis engine 1128 may be configured to determine, for a first one of the nodes, whether first precondition semantic indicators associated with a first edge entering the first one indicate one or more positive values indicating a positive validity of execution of activities associated with the tasks associated with the first one.

According to an example implementation, the semantic model validity manager 1124 may include a semantic postcondition analysis engine 1130 configured to determine, for the second one of the nodes, whether first postcondition semantic indicators associated with a second edge exiting the second one indicate one or more positive values indicating a positive validity of execution of activities associated with the tasks associated with the second one.

According to an example implementation, the semantic model validity manager 124 may include a parallel execution engine 1132 configured to determine a validity of parallel execution of tasks included in the parallel execution structure based on results determined by the semantic precondition analysis engine 1128 and the semantic postcondition analysis engine 1130.

According to an example implementation, the semantic model validity manager 1124 may include a semantic inconsistency analysis engine 1134 configured to determine one or more semantic inconsistencies associated with a flow of execution of the activities associated with the tasks based on the traversing the process semantic model.

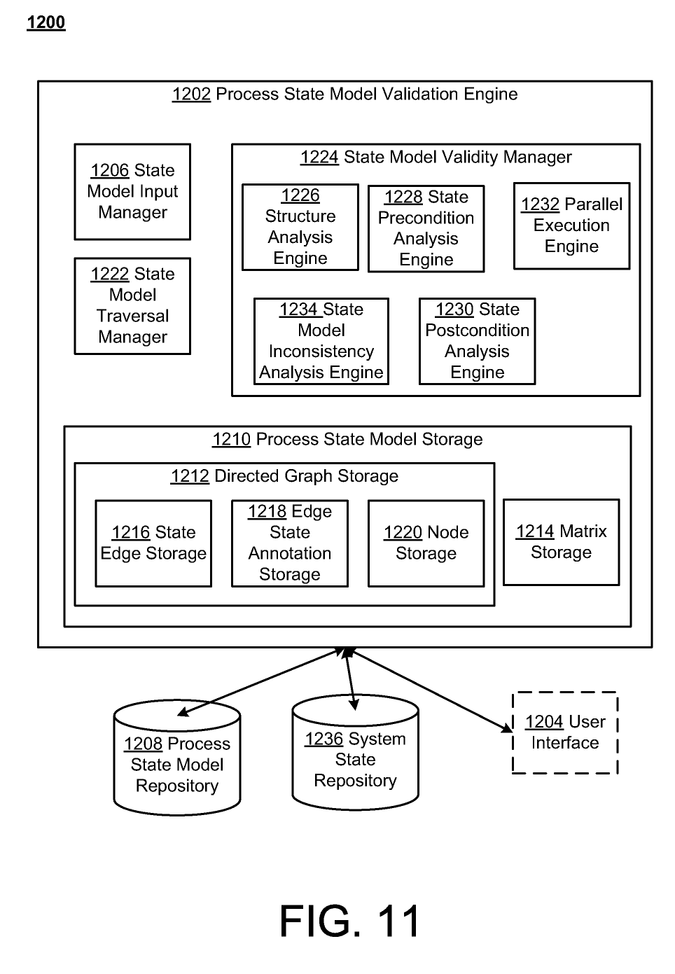

FIG. 11 is a block diagram of a system 1200 for validating process state models, for example, business process models. In the example of FIG. 11, a process state model validation engine 1202 includes various processing engines that provide and process state models that may be displayed, for example, for users via a user interface 1204. For example, the user may view via a graphical user interface process models to determine validity of execution of tasks represented by the process state models.

The state construction component 104 of FIG. 1 may also be referred to as the process state model validation engine 1202 and may perform its functionality in the same or a similar manner. The process state model validation engine 1202 may include a state model input manager 1206 configured to obtain a process state model including a state directed graph including nodes associated with tasks and edges associated with a direction of flow of execution of the tasks, wherein edges entering nodes include state annotations including state precondition indicators indicating state values associated with the edges entering the nodes and edges exiting nodes include state annotations including state postcondition indicators indicating state values associated with the edges exiting the nodes. For example, the state model input manager 1206 may obtain the process state model from a process state model repository 1208 configured to store process state models such as business process models. According to an example implementation, the process state model may include a model associated with web services. According to an example implementation, the web services may include semantic web services.

According to an example implementation, the process state model validation engine 1202 may include a process state model storage area 1210 configured to store information associated with the process state model obtained by the process state model validation engine 1202. According to an example implementation, the process state model storage area 1210 may include a state directed graph storage area 1212 configured to store information associated with the state directed graph, and a matrix storage area 1214 configured to store information associated with a matrix associated with the state directed graph..

According to an example implementation, the state directed graph storage area 1212 may include a state edge storage area 1216 configured to store information associated with the edges, an edge state annotation storage area 1218 configured to store information associated with the edge annotations, and a node storage area 1220 configured to store information associated with the nodes.

According to an example implementation, the process state model validation engine 1202 may include a state model traversal manager 1222 configured to traverse the process state model to determine a flow of execution of activities associated with the tasks, the traversing the process state model including performing logical operations on state annotation values associated with the state annotations based on an ordering of the flow of execution.

According to an example implementation, workflow structures included in the state directed graph may include one or more of a parallel execution workflow structure, a sequential execution workflow structure, a split execution workflow structure, or a merge execution structure. According to an example implementation, paths included in the state directed graph may include a logical sequence of a group of the activities and a list of indicators associated with preconditions and postconditions associated with the group of activities.

According to an example implementation, the process state model validation engine 1202 may include a state model validity manager 1224 configured to determine a validity of execution associated with a flow of execution of the activities associated with the tasks based on the traversing the process state model.

According to an example implementation, the state model traversal manager 1222 may be further configured to perform logical operations on state annotation values associated with the state annotations based on determining state values associated with state preconditions when traversing the process state model visits one of the edges entering one of the nodes, and determining state values associated with state postconditions when traversing the process state model visits one of the edges exiting one of the nodes, based on a depth-first traversal.

According to an example implementation, each of the state precondition indicators may indicate a value associated with a state associated with one or more events associated with the process state model prior to execution of activities associated with the node entered by the edge associated with the each state precondition indicator, and each of the state postcondition indicators may indicate a value associated with a state associated with one or more events associated with the process state model after execution of activities associated with the node exited by the edge associated with the each state postcondition indicator.

According to an example implementation, the state model validity manager 1224 may include a structure analysis engine 1226 configured to determine one or more execution structures included in the workflow structures.

According to an example implementation, the state model validity manager 1224 may include a state precondition analysis engine 1228 configured to determine, for the first one of the nodes, whether first precondition state indicators associated with a first edge entering the first one indicate one or more positive values indicating a positive validity of execution of activities associated with the tasks associated with the first one.

According to an example implementation, the state precondition analysis engine 1228 may be configured to determine a state of a universe based on a state precondition indicator prior to a traversal entry into a node associated with the state precondition indicator.

According to an example implementation, the state model traversal manager 1222 may be further configured to determine a checking indicator indicating a checking relationship between each traversed path and previously traversed paths included in workflow structures included in the state directed graph, wherein each traversed path and each previously traversed path includes one or more nodes included in the state directed graph. For each traversed path, a list of state annotation indicators associated with the precondition state indicators and the postcondition indicators associated with the each traversed path may be generated. The checking indicator may be stored in a matrix that includes rows associated with the paths included in the workflow structures included in the state directed graph, similarly as discussed previously with regard to FIG. 10.

According to an example implementation, the state model validity manager 1224 may be further configured to determine the validity of execution based on determining the validity of execution associated with a flow of execution of the activities associated with the tasks based on checking a validity of execution status based on the checking indicators stored in the matrix and a state processing of the state annotation indicators included in one or more of the lists of state annotation indicators.

According to an example implementation, the structure analysis engine 1226 may be configured to determine that a first and second one of the nodes are included in a parallel execution structure included in the workflow structures.

According to an example implementation, the state precondition analysis engine 1228 may be configured to determine, for the first one of the nodes, whether first precondition state indicators associated with a first edge entering the first one indicate one or more positive values indicating a positive validity of execution of activities associated with the tasks associated with the first one.

According to an example implementation, the state precondition analysis engine 1228 may be configured to determine, for a first one of the nodes, whether first precondition state indicators associated with a first edge entering the first one indicate one or more positive values indicating a positive validity of execution of activities associated with the tasks associated with the first one.

According to an example implementation, the state model validity manager 1224 may include a state postcondition analysis engine 1230 configured to determine, for the second one of the nodes, whether first postcondition state indicators associated with a second edge exiting the second one indicate one or more positive values indicating a positive validity of execution of activities associated with the tasks associated with the second one.

According to an example implementation, the state model validity manager 1224 may include a parallel execution engine 1232 configured to determine a validity of parallel execution of tasks included in the parallel execution structure based on results determined by the state precondition analysis engine 1228 and the state postcondition analysis engine 1230.

According to an example implementation, the state postcondition analysis engine 1230 may be configured to determine a state of a universe based on a state postcondition indicator after a traversal exit from a node associated with the state postcondition indicator.

According to an example implementation, the state model validity manager 1224 may include a state inconsistency analysis engine 1234 configured to determine one or more state inconsistencies associated with a flow of execution of the activities associated with the tasks based on the traversing the process state model.

According to an example implementation, the system 1200 may further include a system state repository 1236 configured to store results of the logical operations on the state annotations. According to an example implementation, the system state repository 1236 may be configured to store values of states associated with the system, for example, based on occurrences of one or more events.

According to an example implementation, an activity may include a description of a measure of work that may represent one logical step within a process. A workflow activity may involve human and/or machine resources to support process execution. According to an example implementation, an activity may be represented as a node, step or task. According to an example implementation, a link, connector or edge may lead from one workflow element to another. Each link may be associated with a source and a target element.

According to an example implementation, a state may include a conjunction of facts that are represented by literals.

According to an example implementation, a precondition may include a logical expression which may be evaluated by a workflow engine to determine whether a process instance or activity within a process instance may be started. According to an example implementation, a precondition may include a set of literals which may be provided by a logical expression. According to an example implementation, all of these literals may represent facts that need to be true so that an activity may be executed.

According to an example implementation, a postcondition may include a logical expression which may be evaluated by a workflow engine to determine whether a process instance or activity within a process instance is completed. According to an example implementation, a postcondition may include a set of literals which may be provided by a logical expression. According to an example implementation, all of these literals may represent facts that are true after the execution of an activity.

According to an example implementation, a path may include a sequence of activities and edges that may originate in a single point in a process model. Thus, all elements on a path may be connected via directed edges, wherein all edges form a sequence and one edge is connected to the start point, a split, or a merge structure. According to an example implementation, a path may map to a split or merge structure from which it originated, and if there is none, to the start point of a process model. According to an example implementation, a path may always reside between two nodes in a process model that are not events or activities. According to an example implementation, a path may include a logical sequence of activities that may all be mapped to the same outgoing connector of a split structure. According to an example implementation, a node may lie within a workflow pattern if it is executed after a split structure and before the merge structure corresponding to the split structure.

According to an example implementation, an ontology may include a formal explicit specification of a shared conceptualization of a domain of interest. According to an example implementation, ontologies may include concepts, which may represent ontological objects that are relevant in a domain of interest, relationships between concepts, or instances, which may represent individuals that are described by the concepts. For example, “Hindenburg” may be described by the concept “zeppelin.”

According to an example implementation, knowledge may be inferred from information based on ontologies. For example, from information such as “A plane is able to fly,” in a discussion regarding things that fly, planes may be inferred as knowledge from the information. Semantic networks and rule based systems that include ontologies may thus serve as knowledge bases. According to an example implementation, it may be possible to determine, in some cases, what was the intention of a user when a specific element of a process model was generated, based on ontologies, with regard to example validation techniques discussed herein. One skilled in the art of data processing may appreciate that there may be many ways to use ontologies.

According to an example implementation, knowledge that is true for a certain domain of interest may be obtained based on ontologies. In this context, domain ontologies may describe concepts in a specific domain of discourse, or a specific set of possibilities. For example, constraints stored in an ontology may be analyzed (e.g., any man may have at most one wife (for a certain domain, e.g., the US)), and inferencing techniques may be used to derive implicit knowledge from explicit knowledge (e.g., if a man marries, then he has either not been married before or he was divorced before the marriage). Such example techniques may include update reasoning or incremental reasoning.

According to an example implementation, ontologies may be used as data stores configured to store information associated with the components of a process model and their relationships. According to an example implementation, an ontology may describe a business process model via instances, wherein each concept of the ontology may describe one part of a process model, such as a split structure, a merge structure or an activity.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the implementations.

What is claimed is:

1. A system comprising:
a semantic process validator that is arranged and configured to include:
a state construction component that is arranged and configured to collect state information for an instance of a process model;
a parallelity checker that is arranged and configured to determine a set of one or more process tasks within the instance of the process model that may be executed in parallel to a selected task; and
a validation coordinator that is arranged and configured to coordinate requests to the state construction component and to the parallelity checker;
a process modeling tool that is arranged and configured to include:
a goal creator that is arranged and configured to construct a constraint set for the selected task using the set of process tasks determined by the parallelity checker, the selected task having a goal; and
a task composer that is arranged and configured to find one or more services to fulfill the goal for the selected task using the constraint set constructed by the goal creator.

2. The system of claim 1 wherein the goal creator is arranged and configured to construct the constraint set for the selected task prior to the task composer finding the one or more services to fulfill the goal for the selected task.

3. The system of claim 1 wherein:
the goal creator is further arranged and configured to compute expanded preconditions for the selected task using the state information for the instance of the process model collected by the state construction component; and
the task composer is further arranged and configured to find the one or more services to fulfill the goal for the selected task using the constraint set constructed by the goal creator and the expanded preconditions computed by the goal creator.

4. The system of claim 3 wherein the goal creator is arranged and configured to compute the expanded preconditions for the selected task prior to the task composer finding the one or more services to fulfill the goal for the selected task.

5. The system of claim 1 wherein the validation coordinator is further arranged and configured to coordinate execution of the parallelity checker prior to execution of the state construction component.

6. The system of claim 1 wherein the process modeling tool further includes a user interface that is arranged and configured to interact with a user and to enable the user to control the process modeling tool.

7. The system of claim 1 wherein the process modeling tool further includes a user interface that is arranged and configured to interact with a user and to enable the user to configure the task composer.

8. The system of claim 1 wherein:
the goal creator is further arranged and configured to compute expanded preconditions for the selected task using the state information for the instance of the process model collected by the state construction component;
the process modeling tool further includes a user interface that is arranged and configured to interact with a user and to enable the user to control the process modeling tool including controlling the task composer by configuring the task controller to remove the constraint set from consideration by the task composer when finding the one or more services to fulfill the goal for the selected task; and
the task composer is further arranged and configured to find the one or more services to fulfill the goal for the selected task using only the expanded preconditions computed by the goal creator.

9. A computer program product for performing task composition, the computer program product being tangibly embodied on a computer-readable medium and including executable code that, when executed, is configured to cause at least one data processing apparatus to execute a semantic process validator, a process modeling tool and a task composer, wherein:
the semantic process validator is arranged and configured to include:
a state construction component that is arranged and configured to collect state information for an instance of a process model;
a parallelity checker that is arranged and configured to determine a set of one or more process tasks within the instance of the process model that may be executed in parallel to a selected task; and
a validation coordinator that is arranged and configured to coordinate requests to the state construction component and to the parallelity checker;
the process modeling tool is arranged and configured to include:
a goal creator that is arranged and configured to compute expanded preconditions for the selected task using the state information for the instance of the process model collected by the state construction component, the selected task having a goal; and
the task composer is arranged and configured to find one or more services to fulfill the goal for the selected task using the expanded preconditions computed by the goal creator.

10. The computer program product of claim 9 wherein the goal creator is arranged and configured to compute the expanded preconditions for the selected task prior to the task composer finding the one or more services to fulfill the goal for the selected task.

11. The computer program product of claim 9 wherein:
the goal creator is further arranged and configured to construct a constraint set for the selected task using the set of process tasks determined by the parallelity checker; and
the task composer is further arranged and configured to find the one or more services to fulfill the goal for the selected task using the constraint set constructed by the goal creator and the expanded preconditions computed by the goal creator.

12. The computer program product of claim 11 wherein the goal creator is arranged and configured to construct the constraint set for the selected task prior to the task composer finding the one or more services to fulfill the goal for the selected task.

13. The computer program product of claim 9 wherein the validation coordinator is further arranged and configured to coordinate execution of the parallelity checker prior to execution of the state construction component.

14. The computer program product of claim 9 wherein the process modeling tool further includes a user interface that is arranged and configured to interact with a user and to enable the user to control the process modeling tool.

15. The computer program product of claim 9 wherein the process modeling tool further includes a user interface that is arranged and configured to interact with a user and to enable the user to configure the task composer.

16. The computer program product of claim 9 wherein:
the goal creator is further arranged and configured to construct a constraint set for the selected task using the set of process tasks determined by the parallelity checker;
the process modeling tool further includes a user interface that is arranged and configured to interact with a user and to enable the user to control the process modeling tool including controlling the task composer by configuring the task controller to remove the expanded preconditions from consideration by the task composer when finding the one or more services to fulfill the goal for the selected task; and
the task composer is further arranged and configured to find the one or more services to fulfill the goal for the selected task using only the constraint set constructed by the goal creator.

17. A method comprising:
collecting state information for an instance of a process model;
determining a set of one or more process tasks within the instance of the process model that may be executed in parallel to a selected task, the selected task having a goal;
coordinating requests for collecting the state information and for determining the set of the one or more process tasks;
constructing a constraint set for the selected task using the set of the one or more process tasks within the instance of the process model that may be executed in parallel to the selected task; and
finding one or more services to fulfill the goal for the selected task using the constraint set.

18. The method as in claim 17 further comprising:
computing expanded preconditions for the selected task using the state information for the instance of the process model; and
wherein finding the one or more services includes finding the one or more services to fulfill the goal for the selected task using the constraint set and the expanded preconditions.

19. The method as in claim 17 further comprising:
computing expanded preconditions for the selected task using the state information for the instance of the process model;
removing the constraint set from consideration when finding the one or more services to fulfill the goal for the selected task; and
wherein finding the one or more services includes finding the one or more services to fulfill the goal for the selected task using only the expanded preconditions.

20. The method as in claim 17 further comprising enabling a user to remove the constraint set from consideration when finding the one or more services to fulfill the goal for the selected task.
